(19) United States
(12) Patent Application Publication
(10) Pub. No.: US 2024/0392910 A1
(43) Pub. Date: Nov. 28, 2024

(54) TURBINE POWERED PIPELINE INTERVENTION GADGET

(71) Applicant: GEOTINKERS INC., Grand Forks, ND (US)

(72) Inventors: Shane Namie, Pomeroy, WA (US); Moones Alamooti, Grand Forks, ND (US); Shane Eiring, Cheyenne Wells, CO (US)

(21) Appl. No.: 18/671,885

(22) Filed: May 22, 2024

Related U.S. Application Data
(60) Provisional application No. 63/503,948, filed on May 23, 2023.

(51) Int. Cl. F16L 55/38; F16L 55/32; F16L 55/46

(52) U.S. Cl. CPC F16L 55/38; F16L 55/32; F16L 55/46

(57) ABSTRACT

The Razorback PIG leads to higher enthalpy, reduced cost, and higher fluid flow efficiency. This design uses adaptive speed control via a contra-propeller drive system, moving against or with the fluid as it travels and cleans along the inside of the pipeline, slowing down and focusing on build-up areas. This device executes tangential components in effect with linear components of velocity, developing vorticity, and results in the rotational movement for the front half of the PIG. The front rotational part excavates scale along pipe walls and reduces utility PIG smearing.

### CROSS REFERENCE TO RELATED APPLICATION[S]

The present disclosure claims priority to the U.S. Provisional Patent Disclosure Ser. No. 63/503,948 filed May 23, 2023.

### BACKGROUND

The present disclosure relates to a pipeline intervention gadget (PIG) for traveling through pipelines through which fluid flows to conduct inspection, cleaning, and other maintenance.

Once a pipeline has been commissioned, it is usually impractical to halt the fluid flow through the pipe, so it is normally necessary for cleaning to take place while fluid flows therethrough.

### SUMMARY

A pipeline intervention gadget to clean the interior of a pipeline according to one disclosed non-limiting embodiment of the present disclosure includes a housing that defines an axis; a turbine that rotates about the axis; a nosecone that rotates about the axis with respect to the housing and a cleaning tool that extends from the nosecone to rotate therewith, the cleaning tool operable to clean the interior of a pipeline.

A further embodiment of any of the foregoing embodiments of the present disclosure includes that the turbine comprises a Kaplan turbine with a multiple of turbine blades rotated by a fluid that flows through the pipeline, each of the turbine blades pivotable about a blade axis transverse to the axis to adjust a movement of the pipeline intervention gadget within the pipeline.

A further embodiment of any of the foregoing embodiments of the present disclosure includes that the turbine at least partially drives the nosecone.

A further embodiment of any of the foregoing embodiments of the present disclosure includes that a control system remote from the pipeline intervention gadget.

A further embodiment of any of the foregoing embodiments of the present disclosure includes that the control system is operable to control the pitch of the Kaplan turbine.

A further embodiment of any of the foregoing embodiments of the present disclosure includes that the control system is operable to control an adjustable iris valve in the housing.

A further embodiment of any of the foregoing embodiments of the present disclosure includes that deploying multiple communication rings into the pipeline to communicate with the control system remote from the pipeline intervention gadget.

A method for cleaning the interior of a pipeline according to one disclosed non-limiting embodiment of the present disclosure includes inserting a pipeline intervention gadget into a pipeline with sediment; controlling a turbine of the pipeline intervention gadget to traverse the pipeline intervention gadget through the pipeline with respect to the sediment and driving a cleaning tool connected to the turbine to reduce the sediment.

A further embodiment of any of the foregoing embodiments of the present disclosure includes that controlling the turbine comprises controlling a pitch of a Kaplan turbine and controlling an aperture of an iris valve in the pipeline intervention gadget.

A further embodiment of any of the foregoing embodiments of the present disclosure includes that inserting the pipeline intervention gadget into the pipeline comprises inserting the pipeline intervention gadget against a flow of fluid in the pipeline.

A further embodiment of any of the foregoing embodiments of the present disclosure includes that inserting the pipeline intervention gadget into the pipeline comprises inserting the pipeline intervention gadget with a flow of fluid in the pipeline.

A further embodiment of any of the foregoing embodiments of the present disclosure includes that controlling the turbine comprises controlling the speed of a coaxial contra-rotating turbine.

A further embodiment of any of the foregoing embodiments of the present disclosure includes that deploying multiple communication rings into the pipeline.

A further embodiment of any of the foregoing embodiments of the present disclosure includes that communicating between at least one of the multiple communication rings and a control interface remote from the pipeline intervention gadget.

A further embodiment of any of the foregoing embodiments of the present disclosure includes that the communication is via an acoustic modem.

A pipeline intervention gadget to clean the interior of a pipeline according to one disclosed non-limiting embodiment of the present disclosure includes a housing that defines an axis; a coaxial contra-rotating turbine mounted to the housing for rotation about the axis; a nosecone that rotates about the axis with respect to the housing, the nosecone at least partially driven by the coaxial contra-rotating turbine, and a cleaning tool that extends from the nosecone to rotate therewith, the cleaning tool operable to clean the interior of a pipeline.

A further embodiment of any of the foregoing embodiments of the present disclosure includes that a self-contained power source to drive the coaxial contra-rotating turbine in response to a control system; the self-contained power source comprises a battery-powered electric motor to drive a shaft connected to a planetary gear system, the electric motor mounted within the housing.

A further embodiment of any of the foregoing embodiments of the present disclosure includes that the coaxial contra-rotating turbine comprises a forward turbine disk and an aft turbine disk, the aft turbine disk, and the nosecone driven by a planetary gear system).

A further embodiment of any of the foregoing embodiments of the present disclosure includes that the forward turbine propeller is driven by a sun gear of a planetary gear system (ring gear), the aft turbine propeller is driven at a ratio of 4:1 to the forward turbine disk.

A further embodiment of any of the foregoing embodiments of the present disclosure includes that a multiple of tension stabilizer arrays mounted to the housing, each of the multiple of tension stabilizer arrays comprising a multiple of spring-loaded wheels arranged parallel to the axis.

Unless expressly indicated otherwise, the preceding features and elements may be combined in various combinations without exclusivity. These features and elements and the operation will become more apparent in light of the following description and the accompanying drawings. It should be appreciated that; however, the following description and drawings are intended to be exemplary in nature and non-limiting.

### BRIEF DESCRIPTION OF THE DRAWINGS

Various features will become apparent to those skilled in the art from the detailed description of the disclosed non-limiting embodiment. The drawings that accompany the detailed description can be briefly described as follows:

FIG. 1-3 are schematic views of a pipeline intervention gadget (PIG) that moves with a fluid flow according to one disclosed non-limiting embodiment.

FIG. 4 is a schematic block diagram of a pipeline intervention gadget (PIG) control system according to one disclosed non-limiting embodiment.

FIG. 5 is a schematic block diagram illustrating the pipeline intervention gadget (PIG) operation according to one disclosed non-limiting embodiment.

FIG. 6 is a schematic view of a pipeline intervention gadget (PIG) that moves against a fluid flow according to another disclosed non-limiting embodiment.

FIG. 7 is a schematic view of a pipeline intervention gadget (PIG) that includes internal motive power according to another disclosed non-limiting embodiment.

FIG. 8-11 are schematic views of a pipeline intervention gadget (PIG) according to another disclosed non-limiting embodiment that includes internal motive power and a geared coaxial contra-rotating turbine.

FIG. 12 is a schematic view of a pipeline intervention gadget (PIG) according to another disclosed non-limiting embodiment with a deployable acoustic modem network.

### DETAILED DESCRIPTION

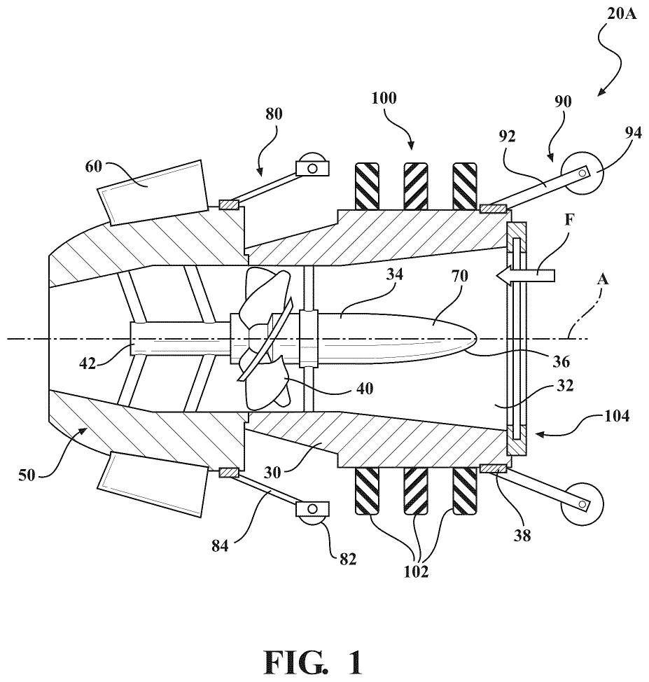

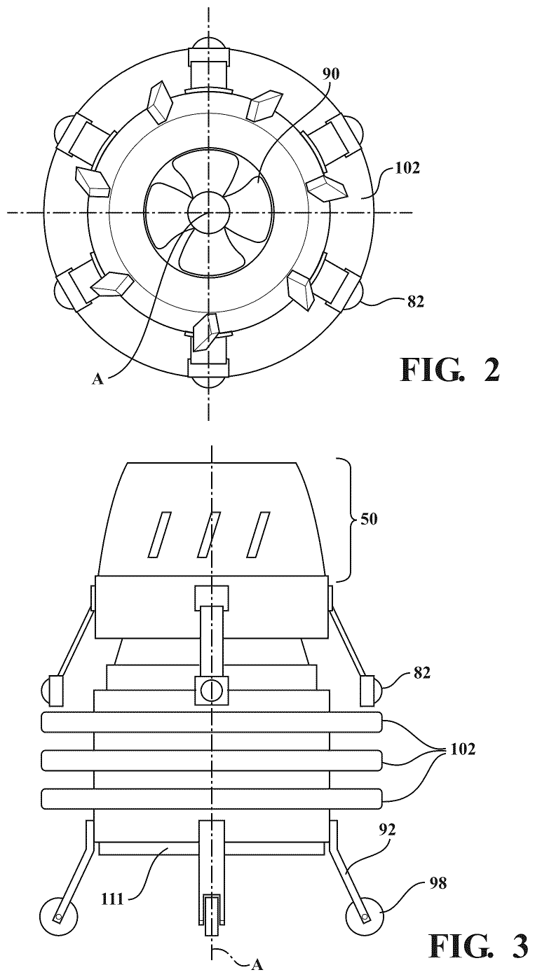

FIG. 1-3 schematically illustrates an embodiment of a pipeline intervention gadget (PIG) 20A that provides enhanced efficiency in pipeline cleaning processes to clean the interior of a pipeline. The PIG 20A may be scaled for different pipeline sizes, e.g., 10, 12, 14, and 16-inch pipeline diameters, and may be variable to encompass a range of sizes, such as 8-12-inch pipeline diameters, 12-16-inch pipeline diameters, etc.

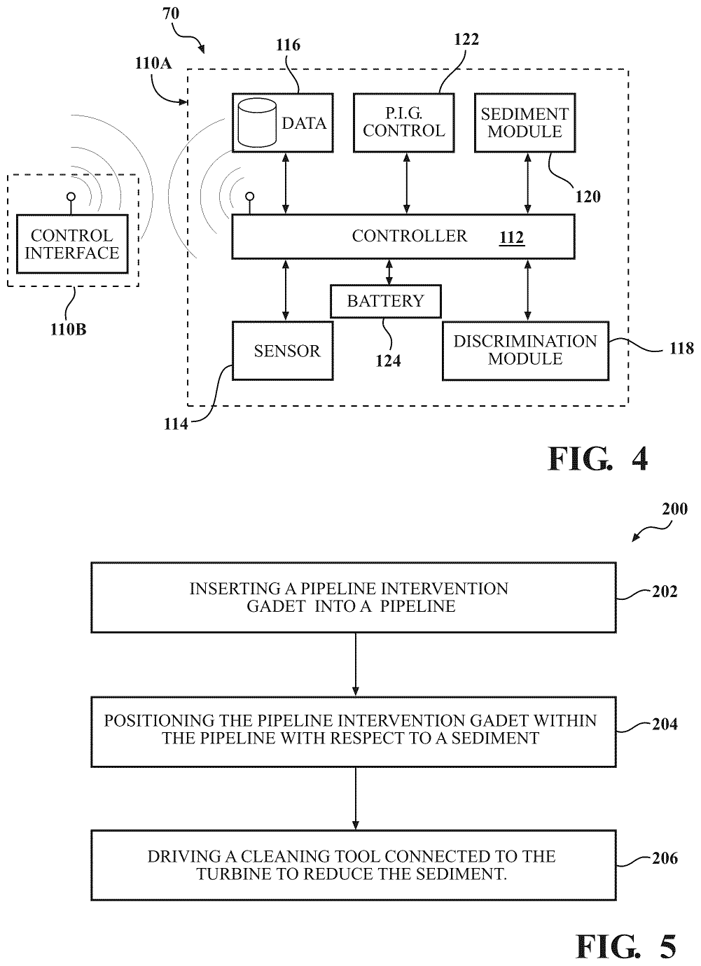

In one embodiment, the PIG 20A generally includes a housing 30 along axis A, a turbine 40 rotationally supported by the housing 30 that rotates about axis A, a nosecone 50 that rotates about axis A with respect to the housing 30, and a cleaning tool 60 that extends from the nosecone 50. The PIG 20A may also include an onboard control system 110A (FIG. 4) that controls the operation of the PIG 20A in response to a remote system 110B (FIG. 4). The remote system 110B may include a control interface such as a laptop, remote device with joysticks, video display, etc.

In this embodiment, the PIG 20A may move in the direction of the fluid flow to clean the pipeline's interior. That is, the motive force of the PIG 20A is the fluid flow through the pipeline. The housing 30 provides an internal annular flow path 32 for the fluid to flow through and drive the turbine 40. The internal annular flow path 32 may include various flow configurations such as convergent flow configuration, conical flow configuration, cylindrical flow configuration, axial flow configuration portion, radial flow configuration portions, etc., and combinations thereof.

The turbine 40 may be rotationally supported by an internal structure 34 within the housing 30. The internal structure 34 may include a conical nose portion 36 along the axis A that faces aftward into the fluid flow (illustrated schematically by arrow F). The conical nose portion 36 minimizes fluid flow disturbance to the turbine 40. Various bearings, bushings, etc., may be mounted within the internal structure 34 to support the turbine 40 rotationally.

In this embodiment, the turbine 40 may be a Kaplan turbine. The Kaplan turbine includes multiple turbine blades, each of the turbine blades pivotable about a blade axis B transverse to axis A to adjust the movement of the PIG 20A within the pipeline. The Kaplan turbine combines features of radial and axial turbines and is generally an inward flow reaction turbine, in which the working fluid changes pressure as it moves through the turbine and gives up its energy. Power is recovered from both the hydrostatic head and the fluid flow's kinetic energy. The inlet may include a scroll-shaped tube that wraps around a wicket gate to direct fluid tangentially. The outlet may include a draft tube that decelerates the fluid to recover kinetic energy.

An exterior 38 of the housing 30 may support various arrays that interface with the pipeline's interior. In one embodiment, a multi-directional roller array 80, a tension stabilizer array 90, and a silicon disc array 100 may extend from the exterior 38. It should be appreciated that various other components that interface with the pipeline's interior may be provided alternatively or additionally.

The multi-directional roller array 80 may include a multiple of legs 84, each of which is raked aftward with respect to a movement direction of the PIG 20A and may extend from the nosecone 50 to support the rotation of the nosecone 50 and the cleaning tool 60 mounted thereto. The multi-directional roller array 80 may include roller balls 82 that accommodate axial and rotational movement as the PIG 20A moves along the pipeline's interior and the nosecone 50 rotates about axis A.

The tension stabilizer array 90 may include a multiple of legs 92, which terminate with engagement members 94, such as wheels, skids, etc. Each of the legs 92 is raked aft ward with respect to the movement direction of the PIG 20A and may extend beyond an aft end 38 of the housing 30. The tension stabilizer array 90 may be radially adjustable to, for example, support the PIG 20A within the interior of the pipeline, control a speed thereof, and/or may also be adjusted to selectively control and/or prevent aftward movement of the PIG 20A. The tension stabilizer array 90 may be selectively radially extended to increase tension on the pipeline's interior. Furthermore, the engagement members 94 may be selectively braked or otherwise controlled to increase friction with the pipeline's interior.

The silicon disc array 100 is arranged axially between the multi-directional roller array 80 and the tension stabilizer array 90. The silicon disc array 100 may include a multiple of disks 102 or wipes that provide a seal between the PIG 20A and the pipeline's interior to direct fluid flow into the internal annular flow path 32.

In this embodiment, the fluid flows through an adjustable iris valve 104 at the aft end 38 of the housing 30 in response to the onboard control system 110A. That is, the adjustable iris valve 104 provides an adjustable diameter to control a fluid flow into the internal annular flow path 32 to, for example, facilitate control of the rotational speed of the turbine 40. The adjustable iris valve 104 may be, for example, a mechanical iris diaphragm that includes a base plate, blades, and a blade actuating ring, a shutter arrangement, an adjustable convergent-divergent nozzle, or other such adjustable valve type structure that can control the flow of the fluid (illustrated schematically by arrow F) into the internal annular flow path 32.

The nosecone 50 is driven by the turbine 40 via a shaft 42 about the axis A with respect to the housing 30 to thereby rotate the cleaning tool 60 that extends from the nosecone 50.

That is the turbine 40 drives the nosecone 50 in response to flow through the iris valve 104 while the tension stabilizer array 90 and the flow through the iris valve 104 controls the movement of the PIG 20A.

The cleaning tool 60 may include a multiple of blades perpendicular to the axis A. The cleaning tool 60 may be interchangeable and specifically tailored to the sediments within the pipeline to include, for example, only a scraper, a brush, or other such tool. The cleaning tool 60 may provide a perpendicular scraping direction, improving cleaning efficiency over non-rotating silicone sleeves or brushes, which often lead to smearing of sediment build-up areas.

With reference to FIG. 4, the onboard control system 110A may include a controller 112 110A, 110B, a sensor system 114, a database 116, a discrimination module 118, a sediment module 120, a PIG control module 122, and a battery 124. Controller 112 may be configured as a central network element or hub with access to various systems and may be implemented in a single processor, one or more processors and/or one or more tangible, non-transitory memories and be capable of implementing logic. Each processor can be a general-purpose processor, a digital signal processor (DSP), an application-specific integrated circuit (ASIC), a field programmable gate array (FPGA), or other programmable logic device, or any combination thereof. Controller 110 may include a processor configured to implement various logical operations in response to executing instructions. For example, instructions may be stored on a non-transitory, tangible, computer-readable medium configured to communicate with other components. Operations to be performed by the controller 112 may be onboard, off board in a cloud off board in the remote-control interface 110B and/or various combinations thereof. In response to execution by the controller, the PIG 20 performs various operations.

The onboard control system 110A controller 112 may be in electronic communication with a user through the remote-control interface 110B for the operator. The remote-control interface 110B may include, for example, a multifunction display, a touch screen, a remote controller, a computer system, etc. The remote-control interface 110B enables a remote user to interact with the PIG 20A to issue commands and display information such as warnings. The onboard control system 110A controller 112 may be in wireless communication with the remote-control interface 110B via, for example, an UAC, SMS, MMS, cellular, GSM, CDMA, Wi-Fi, Wi-Max, wireless transmission, the Internet, LAN, WAN, email, and any wired or wireless paths or combinations thereof. The communication may be in real-time or substantially in real-time.

The sensor system 114 may include, for example, a particulate sensor, a temperature sensor, a torque sensor, a speed sensor, a pressure sensor, a position sensor, an accelerometer, a mass flow sensor, a camera, etc. The sensor system 114 may facilitate the position and operation of the PIG 20A and identification of the sediment through visual and/or other means as well as, for example, debris accumulation, distance traversed, and velocity.

The database 116 may store and maintain data such as sensor data, configuration settings, response models, and/or the like. Data may be stored or recalled from database 116 in response to commands from controller 112.

The controller 112 may also be in electronic communication with the discrimination module 118. The discrimination module 118 may receive sensor data to discriminate between sediment categories. The discrimination module 118 may discriminate between categories and sediment thickness based on the sensor data and algorithms such as the model data 96 which may define the various sediment categories within a look-up table or other relationship. The discrimination module 118 may determine the quantity, size, and type of sediment to control the position of the PIG 20A. In various embodiments, the sensor data may also include GPS data and/or atmospheric data to provide a spatial component to the sediment within the pipeline to thereby control, for example, the speed and/or position of the PIG 20A.

Controller 112 may also communicate electronically with the sediment module 120. The sediment module 120 may receive outputs from the discrimination module 118 and/or the sensor data and is configured to determine a particulate sediment concentration and location within the pipeline to thereby control the location of the PIG 20A via the PIG control module 122 to concentrate on the sediment locations within the pipeline.

The PIG control module 122 may be configured to command the PIG 20A to, for example, instruct the PIG 20A to increase or decrease speeds, control turbine geometry, alter the adjustable iris valve 111, etc. Controller 112 may control the PIG 20A in response to the sediment module 120 and/or discrimination module 118 outputs in various embodiments. Alternately, or in addition, various control decisions may be performed off-board.

With reference to FIG. 5, method 200 of operation is disclosed in terms of functional block diagrams. The logic functions are programmed software routines capable of execution in various microprocessor-based electronics control embodiments and are represented herein as block diagrams. These functions may be enacted in either dedicated hardware circuitry or programmed software routines capable of execution in a microprocessor-based electronics control embodiment such as via controller 112.

Initially, the PIG 20A is inserted into a pipeline (202). In this embodiment, the fluid essentially pushes the PIG 20A through the pipeline such that a diameter of the adjustable iris valve 111 and/or a tension of the tension stabilizer array 90 controls the speed and position of the PIG 20A.

The pitch of the turbine 40 with respect to the fluid flow, the diameter of the adjustable iris valve 111, and/or tension of the tension stabilizer array 90 engagement with the interior of the pipeline may be utilized to control the speed of the turbine 40 within the PIG 20A to position the PIG 20A within the pipeline with respect to sediment (204). The speed of the PIG 20A is controlled within the pipeline with respect to sediment so that the PIG 20A, for example, slows down and/or stops adjacent to particularly heavy sediment deposits to concentrate the cleaning tool 60. The speed of the turbine 40 within the PIG 20A is then controlled to drive the cleaning tool 60 connected to the turbine 40 to reduce the sediment (206).

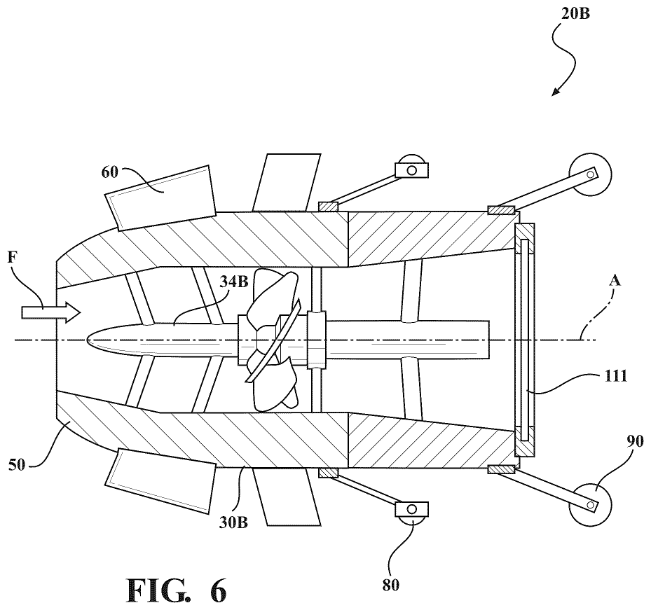

With reference to FIG. 6, another embodiment of the PIG 20B may be operated to move upstream against the fluid in the pipeline. In this embodiment, the internal structure 34B within the housing 30B faces toward the nosecone 50 that rotates about axis A with respect to the housing 30B. That is the nosecone 50 faces into the fluid flow (illustrated schematically by arrow F).

The speed of the turbine 40 within the PIG 20B with respect to the fluid flow, the diameter of the adjustable iris valve 111, and/or the tension of the tension stabilizer array 90 engagement with the interior of the pipeline, may be controlled to position the PIG 20B within the pipeline with respect to sediment. By controlling, for example, the fluid flow through the internal annular flow path 32 by adjustable iris valve 111 and/or the pitch of the turbine 40 with respect to the fluid flow, which is concentrated through the PIG 20B by otherwise blocking the fluid flow via the silicon disc array 100, the PIG 20B is provided with a motive force to move against the fluid flow. The tension of the tension stabilizer array 90 may also be selectively locked to prevent aftward movement of the PIG 20B.

The movement of the PIG 20B within the pipeline against the fluid flow may depend on various factors, including the size and shape of the turbine, the flow rate and viscosity of the fluid, and the dimensions and roughness of the pipeline. In general, the turbine may be designed to have a specific shape and orientation that allows it to generate a net forward force from the fluid flow while also minimizing any drag forces that may impede motion.

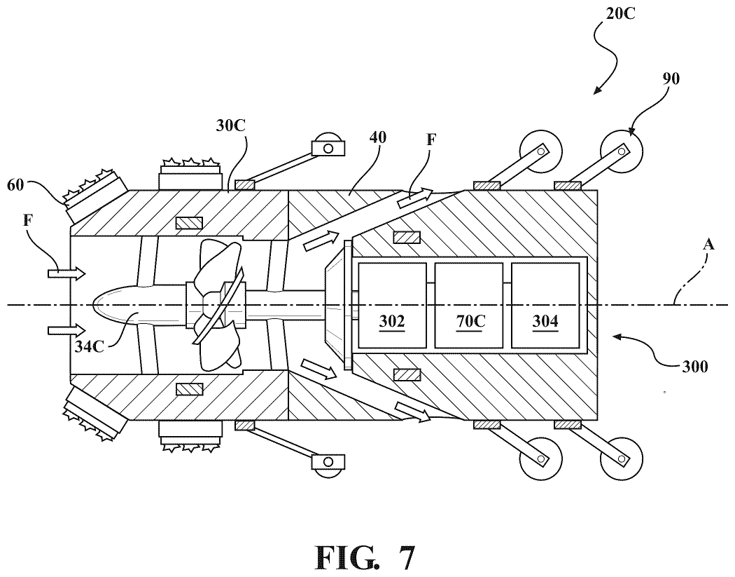

With reference to FIG. 7, another embodiment of the PIG 20C is driven with a self-contained power system 300. The power system 300 may include an electric motor 302 connected to the turbine 40 and a power source 304 such as the battery 124 controlled by the onboard control system 70C, located within the internal structure 34C of the housing 30C. In this embodiment, the flow path from the turbine 40 may be directed off the axis A downstream of the turbine 40 to provide packaging space for the self-contained power system 300. The flow path extends at least partially radially downstream of the turbine 40. The PIG 20C may be selectively driven with the self-contained power system 300, either with or against a fluid flow.

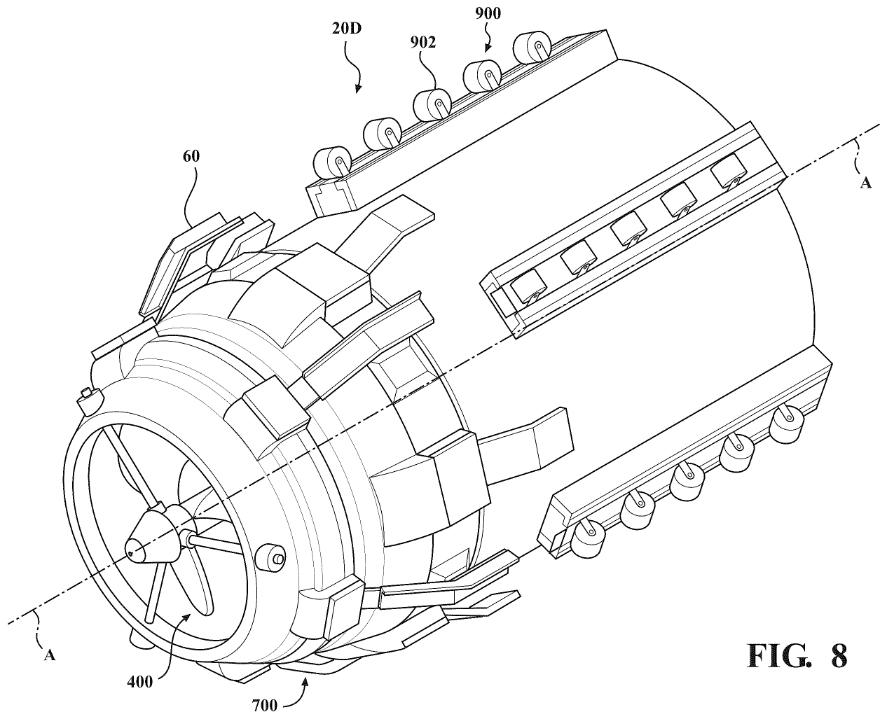

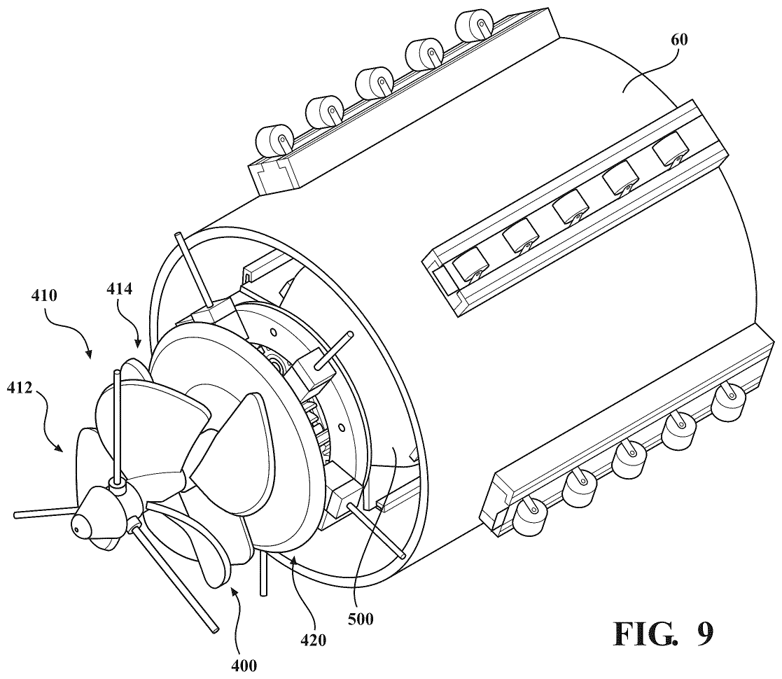

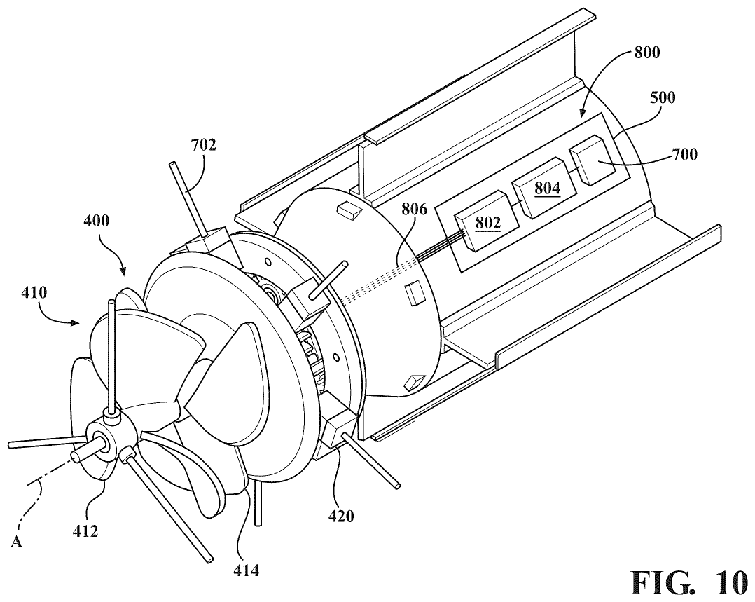

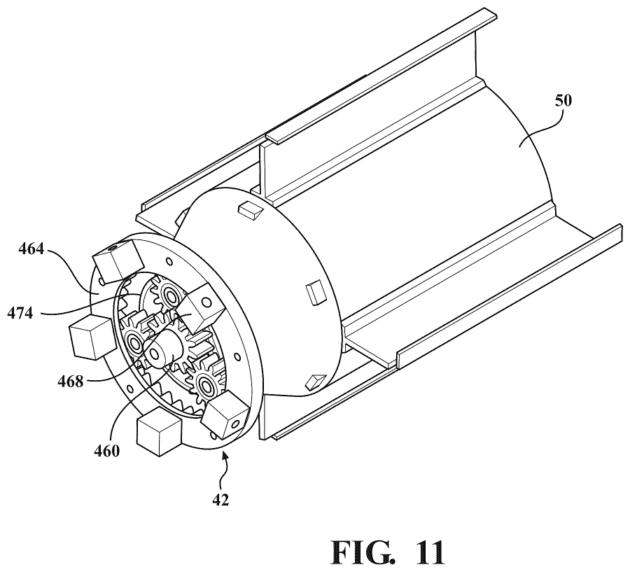

With reference to FIG. 8, in another embodiment, the PIG 20D generally includes a turbine 400 (FIGS. 9 and 10), a geared architecture 420 (FIG. 11), an inner housing 500, an outer housing 600, and a nosecone 700 that is rotatable about the axis A as powered by a self-contained power system 800.

The inner housing 500 (FIGS. 10 and 11) is mounted to the outer housing 600 (FIG. 9) such that an annular flow path is formed therebetween to communicate flow from the turbine 400. The power system 800 may include an electric motor 802 and a power source 804 mounted within the inner housing 500 to drive the turbine 400 through the geared architecture 420 by a shaft 806 as controlled by the onboard control system 70D. The power source 804 may include a battery and electronic speed control located within the inner housing 500.

In this embodiment, the turbine 400 may be a coaxial contra-rotating turbine 410 with a forward turbine disk 412 (FIGS. 9 and 10) and an aft turbine disk 414 driven through the geared architecture 420 (FIG. 11). The geared architecture 420 may be supported by the inner housing 500 (FIG. 11) which contains the self-contained power system 800. A coaxial contra-rotating turbine 410 may cause opposing rotational torques that negate each other.

The example geared architecture 420, in one embodiment, may include an epicyclical gear train, such as a planetary gear system, star gear system or other gear system, with an example gear reduction ratio of about 2:1. Various bearings, bushings, etc. may be mounted within the inner housing 500 to support the geared architecture 420 rotationally.

The geared architecture 420 includes a sun gear 460 driven by the input shaft 806, a ring gear 464 connected to drive the nosecone 700 through standoffs 702, and a set of intermediate gears 468 in meshing engagement with the sun gear 460 and ring gear 464. Each intermediate gear 468 may be mounted on a journal pin, which may each be supported by a carrier 474. The input shaft 806 and the nosecone 700 counter rotate as the sun gear 460 and the ring gear 464 rotate about the central longitudinal axis A. The carrier 474 may be grounded to the inner housing 500 and non-rotatable even though the individual intermediate gears 468 are each rotatable about their respective axes.

The nosecone 700 supports the cleaning tool 60 which may include a multiple of blades 602 perpendicular to the axis A. The cleaning tool 60 may include scrapers that expand and contract within the pipeline to accommodate fluctuations in pipeline diameter during operation. In one example, while traversing and cleaning the pipeline, the tool can adapt between a 12-inch pipe diameter and an 8-inch diameter.

In this embodiment, tension stabilizer arrays 900 include multiple spring-loaded wheels 902 arranged parallel to the axis A. The multiple spring-loaded wheels 902 on the non-rotating outer housing 600 are operable to expand and contract by, for example, about 4 inches to align with the pipeline diameter and thereby facilitate central alignment while accommodating fluctuations in pipeline diameter.

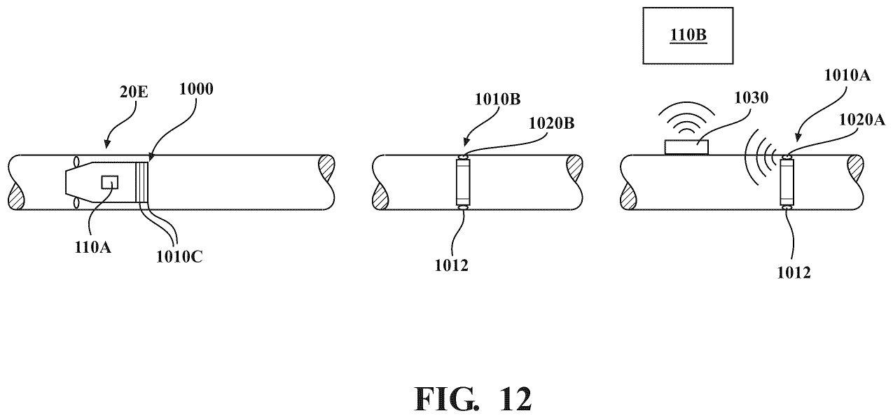

With reference to FIG. 12, in another embodiment, the PIG 20E may include a deployable acoustic modem network 1000 that facilitates instantaneous data transmission between the remote-control interface 110B and the onboard control system 110A of the PIG 20E.

The deployable acoustic modem network 1000 generally includes multiple deployable communication rings 1010a-1010n, each with an acoustic modem 1020a-1020n. The communication rings 1010 may be wireless and/or connected by a wire therebetween and to the onboard control system 110A of the PIG 20E.

The deployable acoustic modem network 1000 individually deploys each of the multiple communication rings 1010a, 1010b, 1010c, 1010n in series into the pipeline. Each communication ring 1010 may include includes a mechanical interface 1012 such as, for example, a camlock which respectively locks the associated communication ring 1010 into the interior of the pipeline such that the multiple communication rings 1010 can be spaced along the length of the pipeline to maintain a wireless communication link with the remote-control interface 110B. In one example, the communication rings 1010 may be located at approximately 300-500 meter intervals.

The communication rings 1010 establish and maintain communication links through the liquid medium, ensuring continuous connectivity with the operator. The communication rings 1010 effectively relay information through the pipeline as the PIG 20E progresses further away from the operator. The communication rings 1010 in one embodiment can communicate with an exterior acoustic modem 1030 affixed to the pipeline's outer surface. Subsequently, the exterior acoustic modem 1030 is operable to relay real-time data and facilitate device control to the remote-control interface 110B. When the cleaning is complete, the PIG 20E returns to the operator within the pipeline and collects the communication rings 1010 for future use. The PIG device provides enhanced efficiency in pipeline cleaning processes while reducing build-up, resulting in lower maintenance costs and time-on-job expenses for geothermal plants, lithium refineries, water utilities, and pipeline maintenance companies. The PIG device may utilize an adaptive control system and rotational cleaning tools, allowing PIG device to adjust to the pipeline debris build-up. The adaptive speed control allows the PIG device to slow down or stop in a heavy debris area, taking more time for operation of the rotational cleaning tools in specific locations.

Although the different non-limiting embodiments have specific illustrated components, the embodiments of this invention are not limited to those particular combinations. It is possible to use some of the components or features from any of the non-limiting embodiments in combination with features or components from any other.

The foregoing description is exemplary rather than defined by the limitations within. Various non-limiting embodiments are disclosed herein; however, one of the ordinary art skills is recognizing that various modifications and variations in light of the above teachings will fall within the scope of the appended claims. It is, therefore, to be appreciated that the disclosure may be practiced other than as specifically described within the scope of the appended claims. Therefore, the appended claims should be studied to determine the true scope and content.

What is claimed is:

1. A pipeline intervention gadget to clean the interior of a pipeline, comprising:
a housing that defines an axis;
a turbine that rotates about the axis;
a nosecone that rotates about the axis with respect to the housing and
a cleaning tool that extends from the nosecone to rotate therewith, the cleaning tool operable to clean the interior of a pipeline.

2. The pipeline intervention gadget, as recited in claim 1, wherein the turbine comprises a Kaplan turbine with a multiple of turbine blades rotated by a fluid that flows through the pipeline, each of the turbine blades pivotable about a blade axis transverse to the axis to adjust a movement of the pipeline intervention gadget within the pipeline.

3. The pipeline intervention gadget, as recited in claim 1, wherein the turbine at least partially drives the nosecone.

4. The pipeline intervention gadget, as recited in claim 1, further comprising a control system remote from the pipeline intervention gadget.

5. The pipeline intervention gadget, as recited in claim 4, wherein the control system is operable to control the pitch of the Kaplan turbine.

6. The pipeline intervention gadget, as recited in claim 4, wherein the control system is operable to control an adjustable iris valve in the housing.

7. The pipeline intervention gadget, as recited in claim 4, further comprises deploying multiple communication rings into the pipeline to communicate with the control system remote from the pipeline intervention gadget.

8. A method for cleaning the interior of a pipeline comprising:
inserting a pipeline intervention gadget into a pipeline with sediment; and
controlling a turbine of the pipeline intervention gadget to traverse the pipeline intervention gadget through the pipeline with respect to the sediment; and
driving a cleaning tool connected to the turbine to reduce the sediment.

9. The method as recited in claim 8, wherein controlling the turbine comprises controlling a pitch of a Kaplan turbine and controlling an aperture of an iris valve in the pipeline intervention gadget.

10. The method as recited in claim 8, wherein inserting the pipeline intervention gadget into the pipeline comprises inserting the pipeline intervention gadget against a flow of fluid in the pipeline.

11. The method as recited in claim 8, wherein inserting the pipeline intervention gadget into the pipeline comprises inserting the pipeline intervention gadget with a flow of fluid in the pipeline.

12. The method, as recited in claim 8, wherein controlling the turbine comprises controlling the speed of a coaxial contra-rotating turbine.

13. The method, as recited in claim 8, further comprises deploying multiple communication rings into the pipeline.

14. The method, as recited in claim 13, further comprises communicating between at least one of the multiple communication rings and a control interface remote from the pipeline intervention gadget.

15. The method, as recited in claim 14, wherein the communication is via an acoustic modem.

16. A pipeline intervention gadget to clean the interior of a pipeline, comprising:
a housing that defines an axis;
a coaxial contra-rotating turbine mounted to the housing for rotation about the axis;
a nosecone that rotates about the axis with respect to the housing, the nosecone at least partially driven by the coaxial contra-rotating turbine, and
a cleaning tool that extends from the nosecone to rotate therewith, the cleaning tool operable to clean the interior of a pipeline.

17. The pipeline intervention gadget, as recited in claim 16, further comprises a self-contained power source to drive the coaxial contra-rotating turbine in response to a control system; the self-contained power source comprises a battery-powered electric motor to drive a shaft connected to a planetary gear system, the electric motor mounted within the housing.

18. The pipeline intervention gadget, as recited in claim 16, wherein the coaxial contra-rotating turbine comprises a forward turbine disk and an aft turbine disk, the aft turbine disk, and the nosecone driven by a planetary gear system).

19. The pipeline intervention gadget, as recited in claim 18, wherein the forward turbine propeller is driven by a sun gear of a planetary gear system (ring gear), the aft turbine propeller is driven at a ratio of 4:1 to the forward turbine disk.

20. The pipeline intervention gadget as recited in claim 16, further comprising a multiple of tension stabilizer arrays mounted to the housing, each of the multiple of tension stabilizer arrays comprising a multiple of spring-loaded wheels arranged parallel to the axis.
